(19) United States
(12) Patent Application Publication
(10) Pub. No.: US 2013/0262884 A1
(43) Pub. Date: Oct. 3, 2013

(54) Low-Frequency Noise Interference Prevention in Power Over Ethernet Systems

(71) Applicant: James Yu, Pleasonton, CA (US)

(72) Inventor: James Yu, Pleasonton, CA (US)

(73) Assignee: BROADCOM CORPORATION, Irvine, CA (US)

(21) Appl. No.: 13/456,810

(22) Filed: Apr. 26, 2012

Related U.S. Application Data
(60) Provisional application No. 61/615,968, filed on Mar. 27, 2012.

(51) Int. Cl. G06F 1/26; H04B 3/00

(52) U.S. Cl. 713/300; 375/257

(57) ABSTRACT

Low-frequency noise interference prevention in power over Ethernet (PoE) systems. A PoE device such as a power sourcing equipment (PSE) and/or a powered device (PD) is coupled to center taps of data transformers on multiple wire pairs used for high-data rate transmission via series high-impedance inductive devices.

This application claims priority to provisional patent application No. 61/615,968, filed Mar. 27, 2012, which is incorporated by reference herein, in its entirety, for all purposes.

### BACKGROUND

### Field of the Invention

The present invention relates generally to network powering systems and methods and, more particularly, to low frequency noise interference prevention in power over Ethernet systems.

### Introduction

Power over Ethernet (PoE) provides a framework for delivery of power from power sourcing equipment (PSE) to a powered device (PD) over Ethernet cabling. Various types of PDs exist, including voice over IP (VoIP) phones, wireless LAN access points, Bluetooth access points, network cameras, computing devices, etc.

In a PoE application such as that described in the IEEE 802.3af (which is now part of the IEEE 802.3 revision and its amendments) and 802.3 at specifications, a PSE can deliver power to a PD over multiple wire pairs. In accordance with IEEE 802.3af, a PSE can deliver up to 15.4 W of power to a single PD over two wire pairs. In accordance with IEEE 802.3 at, on the other hand, a PSE may be able to deliver up to 30 W of power to a single PD over two wire pairs. Other proprietary solutions can potentially deliver higher or different levels of power to a PD. A PSE may also be configured to deliver power to a PD using four wire pairs.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an example embodiment of low frequency noise prevention in a power over Ethernet system.

FIG. 2 illustrates a second example embodiment of low frequency noise prevention in a power over Ethernet system.

FIG. 3 illustrates a third example embodiment of low frequency noise prevention in a power over Ethernet system.

FIG. 4 illustrates an equivalent circuit for a differential data pair.

FIG. 5 illustrates a fourth example embodiment of low frequency noise prevention in a power over Ethernet system.

FIG. 6 illustrates a second equivalent circuit for a differential data pair.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Power over Ethernet (PoE) can be used to deliver power over wire pairs that are used for data transmission. PoE can be applied to various contexts and can be used alongside data transmission standards such as 1000BASE-T, 10 GBASE-T, 40 GBASE-T or higher data-rate transmission systems. The data transformers used in 1000BASE-T and 10 GBASE-T systems can typically have much smaller inductance, and hence lower impedance, as compared to the data transformers used with 10BASE-T and 100BASE-TX systems. In preventing the 1000BASE-T or 10 GBASE-T data transmission signal from being impacted by low frequency noise interference from the PoE subsystem (e.g., noise produced by the switching regulator on PoE devices), a high-impedance device is introduced on the center pin of the data transformer to isolate the low-frequency noise produced by the PoE devices.

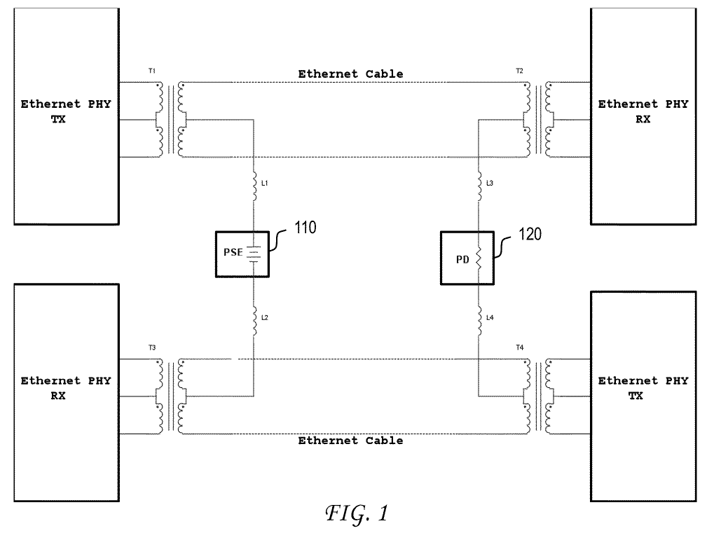

FIG. 1 illustrates an example embodiment of low frequency noise prevention in a PoE system. As illustrated, the PoE system includes PSE 110 that transmits power to PD 120 over two wire pairs. Power delivered by PSE 110 to PD 120 is provided through the application of a voltage across the center taps of data transformer T1 that is coupled to a transmit (TX) wire pair and data transformer T3 that is coupled to a receive (RX) wire pair carried within an Ethernet cable. On the other end of the network link, power is received by PD 120 through the center taps of data transformer T2 and data transformer T4.

In general, PD 120 can include a PoE module (not shown) that contains the electronics that would enable PD 120 to communicate with PSE 110 in accordance with IEEE 802.3af, 802.3 at, legacy PoE transmission, or any other type of PoE transmission. PD 120 also includes a controller (e.g., pulse width modulation DC:DC controller) that controls a power transistor (e.g., field effect transistor (FET)), which in turn provides constant power to a load.

As noted, one of the issues of applying PoE to data transmission systems such as 1000BASE-T or 10 GBASE-T is the impact produced by low-frequency noise interference from the PoE subsystem. For example, consider a 10 GBASE-T system that is operating over a 100 meter Ethernet cable. Such a system is particularly sensitive to low-frequency noise produced by the PD, such that the transmission of power over multiple wire pairs used in the 10G network link can preclude successful transmission of data at 10G rates.

In the example embodiment illustrated in FIG. 1, additional high-impedance inductive elements (e.g., inductors) are used to isolate or attenuate the low-frequency noise that is generated by the PoE devices. Specifically, the high-voltage rail of PSE 110 is injected onto center pins of data transformers T1 and T3 through series high-impedance inductive devices represented by inductors L1 and L2, and PD 120 receives the high DC voltage from the center pins of data transformers T2 and T4 through series high-impedance inductive devices represented by inductors L3 and L4. In operation, the high-impedance inductive devices represented by inductors L1-L4 are configured to isolate the low-frequency noise produced by the PSE and PD devices.

The example embodiment illustrated in FIG. 1 is designed to isolate or attenuate the low-frequency noise from PoE devices on both ends of the link. In other embodiments, one of the PoE devices can be a relatively clean device that does not generate sufficient low-frequency noise that can interfere with the high-data rate transmission signals. In a typical installation, for example, the PD is more likely to create low-frequency noise that can interfere with the high-data rate transmission signals. Where a PoE device is a relatively clean device that does not generate significant low-frequency noise, the PoE device can be coupled to the center taps of the data transformers with little or no series high-impedance inductive devices.

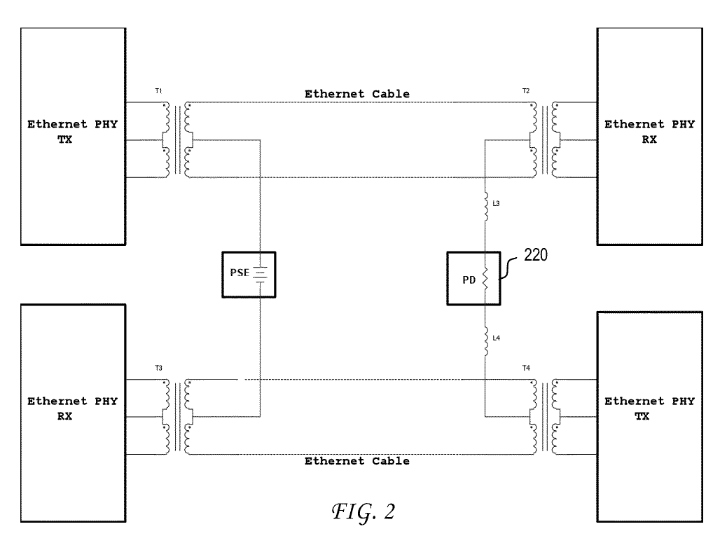

FIG. 2 illustrates a second example embodiment of low frequency noise prevention in a power over Ethernet system. As illustrated, high-impedance devices can be included on one end of the network link. Specifically, PD 220 receives the high DC voltage from the center pins of data transformers T2 and T4 through series high-impedance inductive devices represented by inductors L3 and L4. In this example, no high-impedance inductive devices are added to the PSE side of the PoE system. As would be appreciated, where the PD is a relatively clean device that does not generate sufficient low-frequency noise that can interfere with the high-data rate transmission signals, high-impedance inductive devices can be added to the PSE side and not to the PD side.

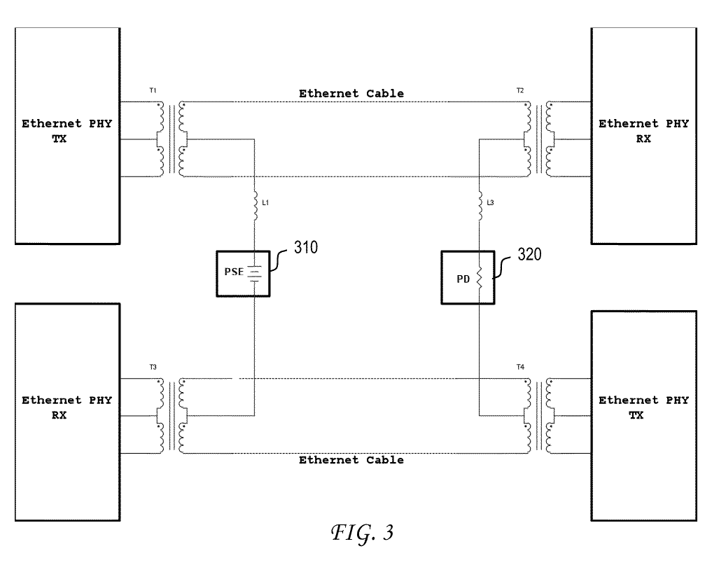

FIG. 3 illustrates a third example embodiment of low frequency noise prevention in a power over Ethernet system. As illustrated, high-impedance inductive devices can be included on one side of the PoE devices. In this example, the high-voltage rail of PSE 310 is injected onto the center pin of data transformers T1 through the series high-impedance inductive device represented by inductor L1, and PD 320 receives the high DC voltage from the center pin of data transformers T2 through the series high-impedance inductive device represented by inductor L3. In operation, the high-impedance inductive devices represented by inductors L1 and L3 are configured to isolate the low-frequency noise produced by the PoE devices. As would be appreciated, other combinations of adding high-impedance inductive devices to one side of the PoE devices can be used without departing from the scope of the present invention.

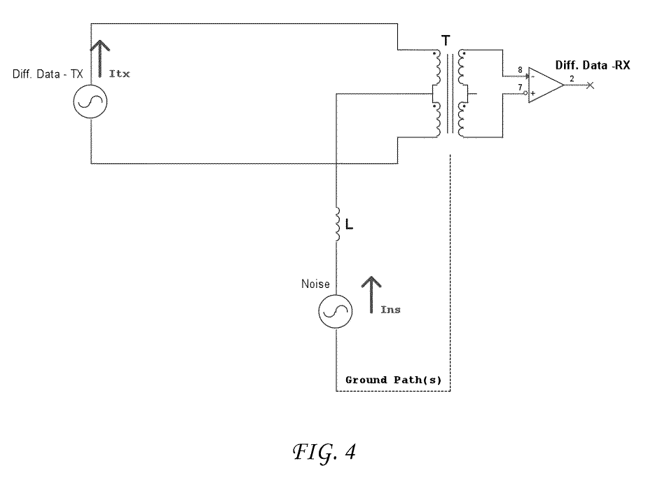

As has been described, one example of a series high-impedance inductive device is a series inductor. FIG. 4 illustrates an equivalent circuit for a differential data pair in the example of a series inductor. As illustrated, current “Itx” flows through both the data cable wires and current “Ins” flows into the center pin of the data transformer and returns through the ground path(s). According to the formula of impedance for the inductor (XL=jωL, ω=2πf), the impedance XL will increase when the value of the inductor increases. Thus, when the value of inductor L is high enough, it will provide proper attenuation for low-frequency noise of the PoE device (“Ins”).

In the present invention, it is recognized that the particular form of the high-impedance device that is used to prevent low-frequency noise interference is implementation dependant. In another example, the high-impedance device can be implemented as a common mode choke.

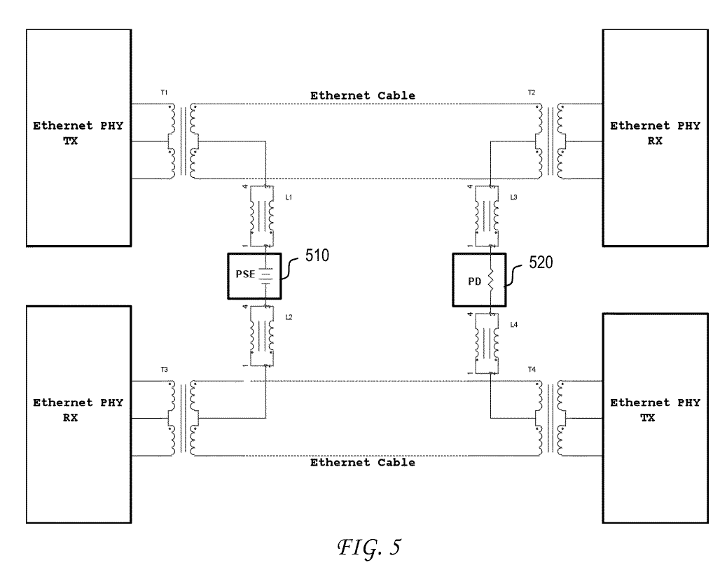

FIG. 5 illustrates a fourth example embodiment of low frequency noise prevention in a power over Ethernet system where the series high-impedance inductive device is embodied as a common mode choke. In the example embodiment illustrated in FIG. 5, common mode chokes L1, L2, L3 and L4 are used to isolate or attenuate the low-frequency noise from the PoE devices. Specifically, the high-voltage rail of PSE 510 is injected onto center pins of data transformers T1 and T3 through common mode chokes L1 and L2, and PD 520 receives the high DC voltage from the center pins of data transformers T2 and T4 through common mode chokes L3 and L4. In operation, the common mode chokes L1-L4 are configured to isolate the low-frequency noise produced by the PoE devices. As would be appreciated, the common mode chokes need not be serially connected to the center taps of every data transformer T1-T4, but can be selectively placed depending on the origin of the low-frequency noise generated by the PoE system.

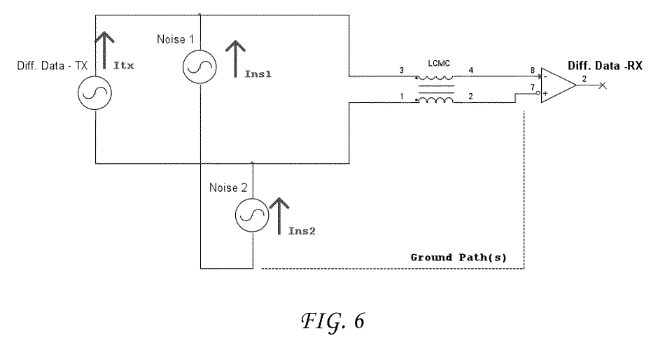

FIG. 6 illustrates a second equivalent circuit for a differential data pair in the example of common mode chokes. Here, the low-frequency noise is treated as a common mode noise (Noise 1 and Noise 2) applied to the differential data pair. Current “Itx” flows through both the data cable wires and currents “Ins1” and “Ins2” each flow through one data cable wire and return through the ground path(s). Observe that current “Itx” flows through both windings but in opposing winding directions, while currents “Ins1” and Ins2″ each flow through only one winding and in the same winding direction. The ground path(s) does not flow through a winding.

The inductance of Winding A restricts (reduces) the flow of current “Ins1” (when compared to FIG. 4), thereby reducing the noise voltage across “Diff. Data−RX”. Similarly the inductance of winding B restricts (hence reduces) the flow of current “Ins2”. Windings A and B have the same number of turns. The ampere-turns created by Current “Itx” (but excluding any “Ins1” current component) flowing through winding A is cancelled by the opposing ampere-turns created by current “Itx” flowing through winding B. Ideally, the cancellation results in zero inductance and no restriction (no reduction) of current “Itx”. “Itx” produces the same voltage across load “Diff. Data−RX”.

As has been described, the prevention of a data transmission signal from being impacted by low frequency noise interference from the PoE subsystem can be enabled through the addition of high-impedance devices on the center pin of the data transformers. The addition of high-impedance devices on the center pins of the data transformers can be applied to any data transmission system that can be impacted by the low-frequency noise produced by the PoE devices.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. Also, it is to be understood that the phraseology and terminology employed herein are for the purposes of description and should not be regarded as limiting.

What is claimed is:

1. A power over Ethernet device, comprising:
a first data transformer that is coupled to a first wire pair in a network cable;
a second data transformer that is coupled to a second wire pair in a network cable; and
a power over Ethernet module that is coupled to a center tap of said first data transformer and a center tap of said second data transformer, said power over Ethernet module being coupled to said center tap of said first data transformer via an inductive element.

2. The power over Ethernet device of claim 1, wherein said inductive element is an inductor.

3. The power over Ethernet device of claim 1, wherein said inductive element is a common mode choke.

4. The power over Ethernet device of claim 1, wherein said power over Ethernet module is coupled to said center tap of said second data transformer via a second inductive element.

5. The power over Ethernet device of claim 1, wherein said power over Ethernet module transmits power via said center tap of said first data transformer and said center tap of said second data transformer.

6. The power over Ethernet device of claim 1, wherein said power over Ethernet module receives power via said center tap of said first data transformer and said center tap of said second data transformer.

7. The power over Ethernet device of claim 1, wherein said first and second data transformers are used for 1000BASE-T transmission.

8. The power over Ethernet device of claim 1, wherein said first and second data transformers are used for 10 GBASE-T transmission.

9. The power over Ethernet device of claim 1, wherein said first and second data transformers are used for 40 GBASE-T transmission.

10. A network powered device, comprising:
a transmitter that is coupled to a first data transformer for data transmission by said transmitter, said first data transformer being coupled to a first copper twisted pair;
a receiver that is coupled to a second data transformer for data reception by said receiver, said second data transformer being coupled to a second copper twisted pair; and
a network powered module that receives power via said first and second copper twisted pair, said network powered module being coupled to a center tap of said first data transformer via a first inductive element and to a center tap of said second data transformer via a second inductive element.

11. The network powered device of claim 10, wherein said first and second data transformers are used for 1000 GBASE-T transmission.

12. The network powered device of claim 10, wherein said first and second data transformers are used for 10 GBASE-T transmission.

13. The network powered device of claim 10, wherein said first and second data transformers are used for 40 GBASE-T transmission.

14. The network powered device of claim 10, wherein said first inductive element is an inductor.

15. The network powered device of claim 10, wherein said first inductive element is a common mode choke element.
